(19) United States
(12) Patent Application Publication
(10) Pub. No.: US 2026/0307883 A1
(43) Pub. Date: Oct. 8, 2026

(54) MICROWAVE HEATABLE FILM, MICROWAVE HEATABLE PACKAGE, AND METHOD FOR PRODUCING MICROWAVE HEATABLE FILM

(71) Applicants: Takaki Hayashi, Colmar (FR); Shohta Koide, Tokyo (JP)

(72) Inventors: Takaki Hayashi, Colmar (FR); Shohta Koide, Tokyo (JP)

(73) Assignee: Ricoh Company, Ltd., Tokyo (JP)

(21) Appl. No.: 19/481,918

(22) PCT Filed: May 30, 2024
(86) PCT No.: PCT/IB2024/055245

§ 371 Date: Nov. 6, 2025

(30) Foreign Application Priority Data
Jun. 9, 2023 (JP) 2023-095770

(51) Int. Cl. B65D 81/34; B32B 7/027; B32B 7/12; B32B 27/08; B32B 27/20

(52) U.S. Cl. CPC B65D 81/3461; B32B 7/027; B32B 7/12; B32B 27/08; B32B 27/20; B32B 2439/70; B65D 2581/344; B65D 2581/3463; B65D 2581/3483

(57) ABSTRACT

A microwave heatable film is provided that includes at least one first microwave heatable region having a first area, and one or more second microwave heatable regions each having a second area. The first area is larger than the second area in a plan view, and the first microwave heatable region and the second microwave heatable regions each have a surface resistivity of 5 Ω/sq to 10,000 Ω/sq.

### TECHNICAL FIELD

The present disclosure relates to a microwave heatable film, a microwave heatable package, and a method for producing the microwave heatable film.

### BACKGROUND ART

A package storing a food material is sometimes heated and cooked in a microwave oven while the food material is sealed inside the package. Thus, when a means for causing steam to be released from the inside of the package is provided in the package, the steam from the food material heated by microwaves is released from the package, allowing the package to exhibit steam permeability.

Examples of such a means for causing the steam to be released from the inside of the package include providing an opening in a heat-sealing portion or an upper portion of the package. Regarding the opening described above, a film-like microwave heatable package that covers a container is disclosed (e.g., see PTL 1). In the film-like microwave heatable package, a coating layer that generates heat by microwaves is provided in a short linear form so that the coating layer is heated by microwave irradiation, thereby instantly weakening the base material of the coating layer to form a steam-releasing opening.

### CITATION LIST

### Patent Literature

[PTL 1]
Japanese Patent No. 6713797

### SUMMARY OF INVENTION

### Technical Problem

In a conventional microwave heatable film, the area of the formed microwave heatable layer is small, thus high-output microwave irradiation is required to release the steam, causing a problem of the low steam permeability.

On the other hand, if the microwave heatable layer is formed over a wide area by solid coating in order to ensure the steam permeability, the steam holes are opened sporadically, resulting in a problem of poor appearance and a fragment of the film falling into the food. An object of the present invention is to provide a microwave heatable film which can exhibit high steam permeability upon irradiation with low-output microwaves and in which the locations where steam holes are formed can be controlled.

### Solution to Problem

Embodiments of the present invention provide a microwave heatable film including at least one first microwave heatable region having a first area, and one or more second microwave heatable regions each having a second area. The first area is larger than the second area in a plan view, and the first microwave heatable region and the second microwave heatable regions each have a surface resistivity of 5 Ω/sq or more and 10,000 Ω/sq or less.

### Advantageous Effects of Invention

The microwave heat film according to embodiments of the present invention exhibits high steam permeability upon irradiation with low-output microwaves and in which the locations where steam holes are formed can be controlled.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic cross-sectional diagram illustrating a microwave heatable film according to one embodiment.

FIG. 2 is a schematic cross-sectional diagram illustrating a microwave heatable film according to one embodiment.

FIG. 3 is a schematic cross-sectional diagram illustrating a microwave heatable film according to one embodiment.

FIG. 4 is a schematic cross-sectional diagram illustrating a microwave heatable film according to one embodiment.

FIG. 5 is a schematic cross-sectional diagram illustrating a microwave heatable film according to one embodiment.

FIG. 6 is a schematic plan diagram illustrating the shape of a microwave heatable layer in a microwave heatable film according to one embodiment.

FIG. 7 is a schematic plan diagram illustrating the shape of a microwave heatable layer in a microwave heatable film according to one embodiment.

FIG. 8 is a schematic plan diagram illustrating the shape of a microwave heatable layer in a microwave heatable film according to one embodiment.

FIG. 9 is a schematic plan diagram illustrating the shape of a microwave heatable layer in a microwave heatable film according to one embodiment.

FIG. 10 is a schematic plan diagram illustrating the shape of a microwave heatable layer in a microwave heatable film according to one embodiment.

FIG. 11 is a schematic plan diagram illustrating the shape of a microwave heatable layer in a microwave heatable film according to one embodiment.

FIG. 12 is a schematic plan diagram illustrating the shape of a microwave heatable layer in a microwave heatable film according to one embodiment.

FIG. 13 is a schematic plan diagram illustrating the shape of a microwave heatable layer in a microwave heatable film according to one embodiment.

FIG. 14 is a schematic plan diagram illustrating the shape of a microwave heatable layer in a microwave heatable film according to one embodiment.

FIG. 15 is a perspective diagram illustrating a microwave heatable package according to one embodiment.

FIG. 16 is a schematic plan diagram illustrating the shape of a microwave heatable layer in a microwave heatable film according to Comparative example 1.

FIG. 17 is a schematic plan diagram illustrating the shape of a microwave heatable layer in a microwave heatable film according to Comparative example 2.

FIG. 18 is a schematic plan diagram illustrating the shape of a microwave heatable layer in a microwave heatable film according to Comparative example 5.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element 4 includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present invention are described in detail below. Note that, in the present specification, the term “releasing steam” means that a steam-releasing hole (in the present specification, also referred to as a “steam hole”) is formed.

### <Microwave Heatable Film>

A microwave heatable film according to embodiments of the present invention is described. The microwave heatable film includes a base material, at least one first microwave heatable region having a first area, and one or more second microwave heatable regions each having a second area. The microwave heatable film may further include, if necessary, a sealant, an adhesive layer, a printing ink layer, an anchor coat layer, an overcoat layer, and other layers.

Examples of the microwave heatable film according to embodiments are illustrated in FIG. 1 to FIG. 5.

As illustrated in FIG. 1, a microwave heatable film 100 includes a base material 11 and a microwave heatable layer 1. The microwave heatable layer 1 includes at least one first microwave heatable region and one or more second microwave heatable regions. The microwave heatable layer 1 is laminated on the base material 11.

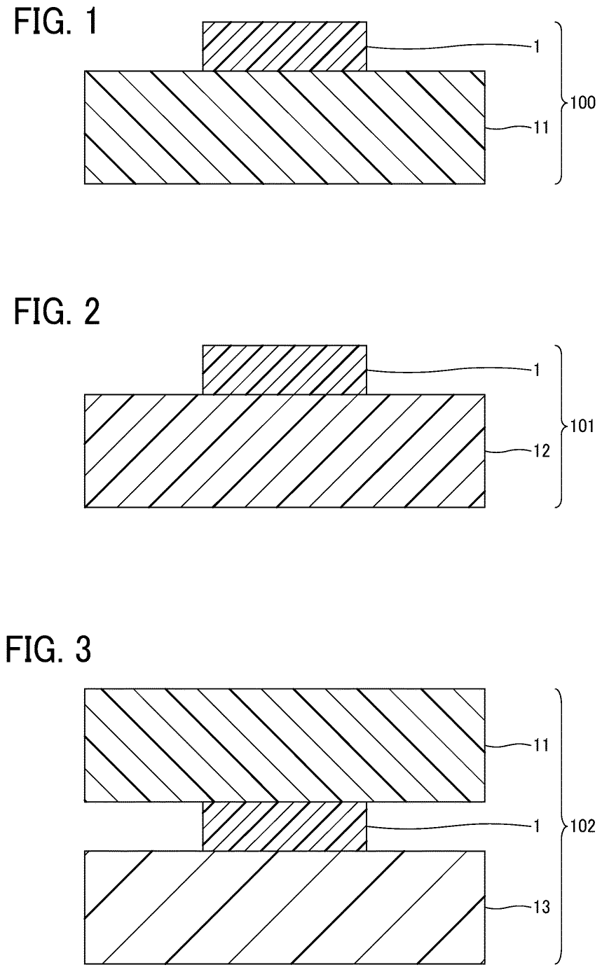

As illustrated in FIG. 2, a microwave heatable film 101 includes a base material 12 with sealing properties and the microwave heatable layer 1. The microwave heatable layer 1 is laminated on the base material 12 with sealing properties.

As illustrated in FIG. 3, a microwave heatable film 102 includes the base material 11, the microwave heatable layer 1, and a sealant 13. The microwave heatable layer 1 is laminated on the sealant 13, and the base material 11 is laminated on the microwave heatable layer 1.

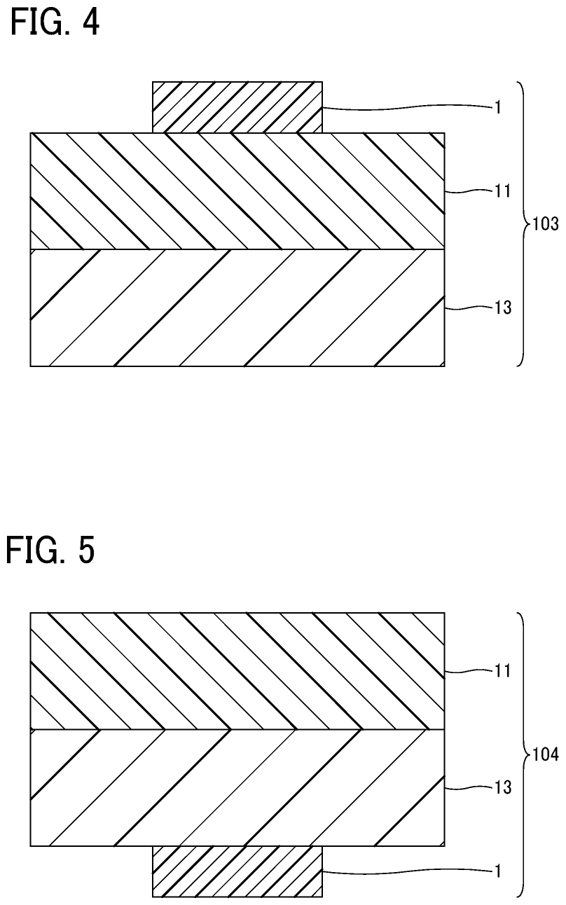

As illustrated in FIG. 4, in a microwave heatable film 103, the lamination order of the base material 11 and the microwave heatable layer 1 is opposite to that in the microwave heatable film 102 illustrated in FIG. 3. The microwave heatable film 103 includes the base material 11, the microwave heatable layer 1, and the sealant 13. The base material 11 is laminated on the sealant 13, and the microwave heatable layer 1 is laminated on the base material 11.

As illustrated in FIG. 5, in a microwave heatable film 104, the microwave heatable layer 1 is provided on the sealant 13 on the side opposite to the base material 11, which is different 5 from the microwave heatable film 102 illustrated in FIG. 3. The microwave heatable film 104 includes the base material 11, the microwave heatable layer 1, and the sealant 13. The sealant 13 is laminated on the microwave heatable layer 1, and the base material 11 is laminated on the sealant 13.

### [First Microwave Heatable Region and Second Microwave Heatable Region]

The first microwave heatable region and the second microwave heatable region are layers formed with a microwave heatable composition (hereinafter also referred to as “microwave heatable layer”).

One embodiment of the present invention provides a microwave heatable film including at least one first microwave heatable region having a first area and one or more second microwave heatable regions each having a second area, in which the first area is larger than the second area in a plan view, and the first microwave heatable region and the second microwave heatable regions each have a surface resistivity of 5 Ω/sq or more and 10,000 Ω/sq or less.

Further, the second microwave heatable region is located near the first microwave heatable region. The second microwave heatable region located near the first microwave heatable region prevents heat generated by microwaves in the first microwave heatable region from being dissipated, causing an increase in temperature preferentially in a target region. That is, in the present disclosure, the term “near” means a certain distance at which the heat dissipation of the first microwave heatable region is prevented by the second microwave heatable region.

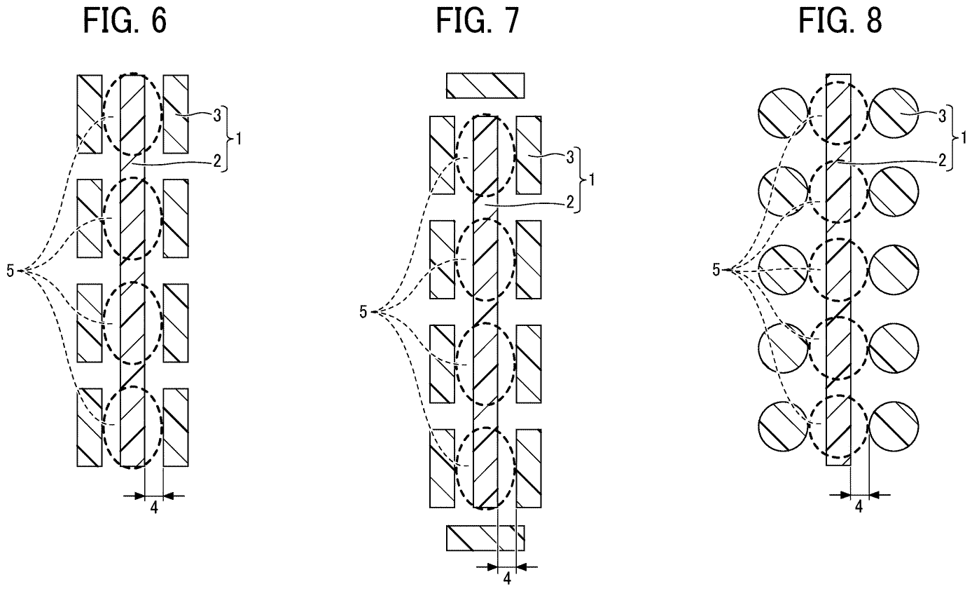

FIG. 6 to FIG. 14 are schematic plan diagrams illustrating examples of the shape of the microwave heatable layer in the microwave heatable film according to embodiments.

In the embodiment illustrated in FIG. 6, the microwave heatable layer 1 includes one first microwave heatable region 2 having a first area and a plurality of (eight) second microwave heatable regions 3 each having a second area at positions a predetermined distance away from the first microwave heatable region 2 on the left and right sides in a plan view.

The first area is larger than the second area in the plan view. The microwave heatable layer 1 including the first microwave heatable region 2 and the second microwave heatable regions 3 can form a steam hole in a target region 5 on the first microwave heatable region 2 near the second microwave heatable regions 3. The target region 5 is a region where the steam hole is desired to be formed.

In the embodiment illustrated in FIG. 6, the first microwave heatable region has a rectangular shape, and the second microwave heatable regions have a rectangular shape.

In the embodiment illustrated in FIG. 6, the shortest distance between the first microwave heatable region and the second microwave heatable region is represented by 4.

The first area means the area of one first microwave heatable region in a case where there are a plurality of first microwave heatable regions 2.

The second area means the area of one second microwave heatable region in a case where there are a plurality of second microwave heatable regions 3.

In the embodiment illustrated in FIG. 7, the microwave heatable layer 1 includes one first microwave heatable region 2 having a first area and a plurality of (ten) second microwave heatable regions 3 each having a second area at positions a predetermined distance away from the first microwave heatable region 2 on the left and right sides and the upper and lower sides in a plan view. The first area is larger than the second area in the plan view. The microwave heatable layer 1 including the first microwave heatable region 2 and the second microwave heatable regions 3 can form the steam hole in the target region 5 on the first microwave heatable region 2 near the second microwave heatable regions 3.

In the embodiment illustrated in FIG. 7, the first microwave heatable region has a rectangular shape, and the second microwave heatable regions have a rectangular shape.

In the embodiment illustrated in FIG. 7, the shortest distance between the first microwave heatable region and the second microwave heatable region is represented by 4.

In the embodiment illustrated in FIG. 8, the microwave heatable layer 1 includes one first microwave heatable region 2 having a first area and a plurality of (ten) second microwave heatable regions 3 each having a second area at positions a predetermined distance away from the first microwave heatable region 2 on the left and right sides in a plan view. The first area is larger than the second area in the plan view. The microwave heatable layer 1 including the first microwave heatable region 2 and the second microwave heatable regions 3 can form the steam hole in the target region 5 on the first microwave heatable region 2 near the second microwave heatable regions 3.

In the embodiment illustrated in FIG. 8, the first microwave heatable region has a rectangular shape, and the second microwave heatable regions have a circular shape.

In the embodiment illustrated in FIG. 8, the shortest distance between the first microwave heatable region and the second microwave heatable region is represented by 4.

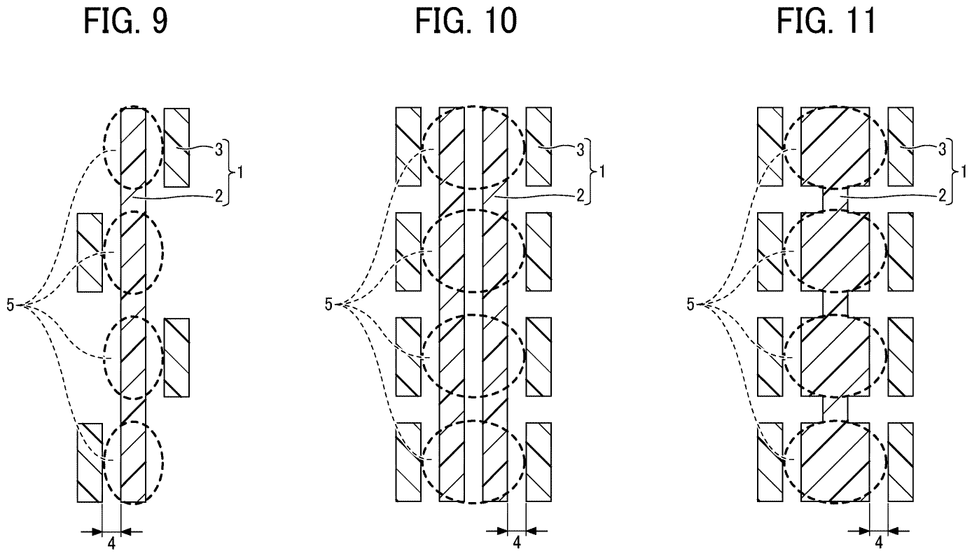

In the embodiment illustrated in FIG. 9, the microwave heatable layer 1 includes one first microwave heatable region 2 having a first area and a plurality of (four) second microwave heatable regions 3 each having a second area located at positions a predetermined distance away from the first microwave heatable region 2 on the left or right side in a plan view. The first area is larger than the second area in the plan view. The first area is larger than the second area in the plan view. The microwave heatable layer 1 including the first microwave heatable region 2 and the second microwave heatable regions 3 can form the steam hole in the target region 5 on the first microwave heatable region 2 near the second microwave heatable regions 3.

In the embodiment illustrated in FIG. 9, the first microwave heatable region has a rectangular shape, and the second microwave heatable regions have a rectangular shape.

In the embodiment illustrated in FIG. 9, the shortest distance between the first microwave heatable region and the second microwave heatable region is represented by 4.

In the embodiment illustrated in FIG. 10, the microwave heatable layer 1 includes a plurality of (two) first microwave heatable regions 2 each having a first area and a plurality of (eight) second microwave heatable regions 3 each having a second area at positions a predetermined distance away from the first microwave heatable regions 2 on the left and right sides in a plan view. The first area is larger than the second area in the plan view. The microwave heatable layer 1 including the first microwave heatable regions 2 and the second microwave heatable regions 3 can form the steam hole in the target region 5 on the first microwave heatable regions 2 near the second microwave heatable regions 3.

In the embodiment illustrated in FIG. 10, the first microwave heatable regions have a rectangular shape, and the second microwave heatable regions have a rectangular shape. In the embodiment illustrated in FIG. 10, the shortest distance between the first microwave heatable region and the second microwave heatable region is represented by 4.

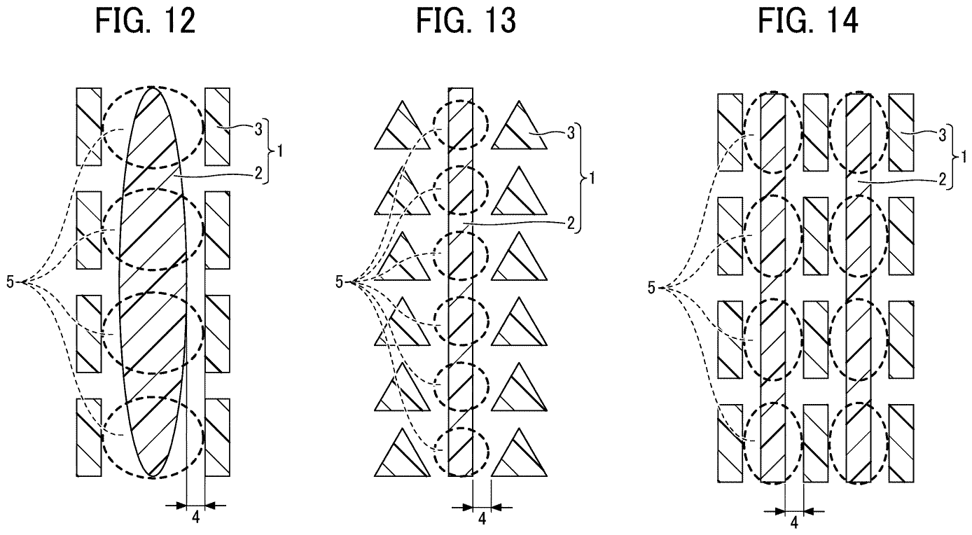

In the embodiment illustrated in FIG. 11, the microwave heatable layer 1 includes one first microwave heatable region 2 having a first area and a plurality of (eight) second microwave heatable regions 3 each having a second area at positions a predetermined distance away from the first microwave heatable region 2 on the left and right sides in a plan view. The first area is larger than the second area in the plan view. The microwave heatable layer 1 including the first microwave heatable region 2 and the second microwave heatable regions 3 can form the steam hole in the target region 5 on the first microwave heatable region 2 near the second microwave heatable regions 3.

In the embodiment illustrated in FIG. 11, the first microwave heatable region has a rectangular shape with three recesses on both left and right sides, and the second microwave heatable regions have a rectangular shape.

In the embodiment illustrated in FIG. 11, the shortest distance between the first microwave heatable region and the second microwave heatable region is represented by 4.

In the embodiment illustrated in FIG. 12, the microwave heatable layer 1 includes one first microwave heatable region 2 having a first area and a plurality of (eight) second microwave heatable regions 3 each having a second area at positions a predetermined distance away from the first microwave heatable region 2 on the left and right sides in a plan view. The first area is larger than the second area in the plan view. The microwave heatable layer 1 including the first microwave heatable region 2 and the second microwave heatable regions 3 can form the steam hole in the target region 5 on the first microwave heatable region 2 near the second microwave heatable regions 3.

In the embodiment illustrated in FIG. 12, the first microwave heatable region has an elliptical shape, and the second microwave heatable regions have a rectangular shape.

In the embodiment illustrated in FIG. 12, the shortest distance between the first microwave heatable region and the second microwave heatable region is represented by 4.

In the embodiment illustrated in FIG. 13, the microwave heatable layer 1 includes one first microwave heatable region 2 having a first area and a plurality of (twelve) second microwave heatable regions 3 each having a second area at positions a predetermined distance away from the first microwave heatable region 2 on the left and right sides in a plan view. The first area is larger than the second area in the plan view. The first area is larger than the second area in the plan view. The microwave heatable layer 1 including the first microwave heatable region 2 and the second microwave heatable regions 3 can form the steam hole in the target region 5 on the first microwave heatable region 2 near the second microwave heatable regions 3. In the embodiment illustrated in FIG. 13, the first microwave heatable region has a rectangular shape, and the second microwave heatable regions have a polygonal (triangular) shape.

In the embodiment illustrated in FIG. 13, the shortest distance between the first microwave heatable region and the second microwave heatable region is represented by 4.

In the embodiment illustrated in FIG. 14, the microwave heatable layer 1 includes a plurality of (two) first microwave heatable regions 2 each having a first area and a plurality of (twelve) second microwave heatable regions 3 each having a second area located at positions a predetermined distance away from the first microwave heatable regions 2 on the left and right sides in a plan view. The first area is larger than the second area in the plan view. The microwave heatable layer 1 including the first microwave heatable regions 2 and the second microwave heatable regions 3 can form the steam hole in the target region 5 on the first microwave heatable regions 2 near the second microwave heatable regions 3.

In the embodiment illustrated in FIG. 14, the first microwave heatable regions have a rectangular shape, and the second microwave heatable regions have a rectangular shape. In the embodiment illustrated in FIG. 14, the shortest distance between the first microwave heatable region and the second microwave heatable region is represented by 4.

The number of the first microwave heatable regions is not particularly limited and can be selected as appropriate depending on the purpose. For example, the number may be one as presented in FIGS. 6 to 9 and FIGS. 11 to 13, two as presented in FIGS. 10 and 14, or three or more.

The number of the second microwave heatable regions is not particularly limited and can be selected as appropriate depending on the purpose. For example, the number may be one, or two or more as presented in FIG. 6 to FIG. 14.

The shape of the first microwave heatable region 2 and the second microwave heatable region 3 is not particularly limited and can be selected as appropriate depending on the purpose. Example of the shape include a circular shape, an elliptical shape, a polygonal shape, and a wavy shape as presented in FIG. 6 to FIG. 14.

The first microwave heatable region 2 and the second microwave heatable region 3 each have a surface resistivity of 5 Ω/sq or more and 10,000 Ω/sq or less, preferably 5 Ω/sq or more and 5,000 Ω/sq or less, more preferably 5 Ω/sq or more and 2,500 Ω/sq or less. When the surface resistivity is 5 Ω/sq or more and 10,000 Ω/sq or less, heat is generated in the microwave heatable region by absorbing microwaves. When the surface resistivity is less than 5 Ω/sq, heat is not generated due to poor absorption of microwaves caused by a large microwave reflection effect. Further, when the surface resistivity is more than 10,000 Ω/sq, heat is not generated because only a small amount of microwaves is absorbed.

It is preferable that the surface resistivity of the first microwave heatable region and the surface resistivity of the second microwave heatable region have the same value. This makes it possible to use the same microwave heatable ink, thereby simplifying the production step.

There is no particular limitation on a method for measuring the surface resistivity, and the method can be selected as appropriate depending on the purpose. For example, the surface resistivity can be measured using a 2-terminal resistance measuring device (tester), a 4-terminal resistance measuring device, or the like.

The shortest distance 4 between the first microwave heatable region 2 and the second microwave heatable region 3 is preferably 100 mm or less.

The film thickness of the first microwave heatable region 2 and the second microwave heatable region 3 is preferably 0.01 μm or more and 100 μm or less, more preferably 0.05 μm or more and 10 μm or less. This improves the blocking resistance of a coated product including the microwave heatable layer.

The length of the first microwave heatable region 2 in the longitudinal direction is preferably twice or more the length of the second microwave heatable region 3 in the longitudinal direction.

When the microwave heatable layer includes a plurality of second microwave heatable regions, the plurality of second microwave heatable regions are preferably positioned along the longitudinal direction of the first microwave heatable region.

Further, the plurality of second microwave heatable regions are preferably positioned on the left and right sides of the first microwave heatable region in a plan view.

The microwave heatable layer can be formed by, for example, applying the microwave heatable composition onto at least one main surface of the base material. A coating method is not particularly limited, and any general coating method may be used.

### [[Microwave Heatable Composition]]

The microwave heatable composition includes a conductive material and, if necessary, other components.

### (Conductive Material)

Examples of the conductive material include an inorganic material such as carbon black or graphite, metal, an alloy, or a metal oxide, such as silver, aluminum, zinc oxide, tin oxide, or iron oxide, and an organic material such as a thiophene-based material, an aniline-based material, or a pyrrole-based material. Of these, from the viewpoint of transparency, an organic material is preferable, and a thiophene-based material is more preferable.

### (Other Components)

Other components are not particularly limited and can be selected as appropriate depending on the purpose. Examples of other components include a dopant, a solvent, a coloring material, a solvent, a wax, a pigment dispersant, other resins, and a crosslinking agent.

### [Base Material]

The base material is preferably at least one selected from a paper sheet, a plastic film or sheet, and a laminate thereof with sealing properties. Examples of the plastic film or sheet include a polyester film such as polyethylene terephthalate (PET) or polyethylene naphthalate (PEN), a polyolefin film such as polyethylene, polypropylene, or ethylene-vinyl acetate, a polystyrene film, an alcohol-based film such as an ethylene-vinyl alcohol or a polyvinyl alcohol, a polyamide film or a barrier polyamide film having a barrier layer in the middle, a transparent vapor-deposited polyester film or a transparent vapor-deposited polyamide film obtained by providing a vapor-deposited layer of alumina, silica, or the like on cellophane, moisture-proof cellophane, a PET film, or a polyamide film, and various coating films coated with a polyvinylidene chloride resin, a polyvinyl alcohol resin, a polyacrylic acid resin, an easy-adhesive resin, or the like. These materials may be stretched or unstretched, and one or more of these materials may be laminated. The appropriate material can be selected by considering mechanical strength, dimensional stability, and the like.

Further, in order to improve the adhesion with the microwave heatable composition, the coating surface of the base material may be subjected to a corona treatment, a low-temperature plasma treatment, a flame treatment, a solvent treatment, a coating treatment, or the like, or the base material pre-applied with these treatments may be selected.

Further, the base material may be obtained by laminating thermoplastic resins or the like using a method such as dry lamination, non-solvent lamination, or extrusion lamination, a method such as adhesive-mediated bonding, or a method in which these methods are appropriately combined. A uniaxially stretched film, an easy-to-cut film, a stretch film, or a shrink film may also be used for the base material.

Further, as the base material, a laminate with sealing properties may be used. Examples of a method for imparting sealing properties include bonding with a known sealant film or sheet and resin coating through extrusion lamination processing. A layer imparted with sealing properties by these methods is referred to as a sealant.

Further, the base material may be subjected to scratching processing in advance.

The thickness of the base material is not particularly limited as long as the thickness is in a range that does not interfere with printability, windability, and the like. However, the thickness is preferably 5 μm to 300 μm, more preferably 6 μm to 250 μm.

### [Sealant]

The sealant is preferably a layer including a resin with sealing properties. Examples of the resin which can be used include a thermoplastic resin such as a polyethylene resin such as LDPE, LLDPE, HDPE, or metallocene polyethylene, a polypropylene resin, an ethylene-vinyl acetate copolymer, an ionomer resin, an ethylene-acrylic acid copolymer, an ethylene-ethyl acrylate copolymer, an ethylene-methyl acrylate copolymer, an ethylene-methacrylic acid copolymer, an ethylene-methyl methacrylate copolymer, an ethylene-propylene copolymer, a methylpentene polymer, an acid-modified polyolefin resin made by modifying polyethylene or polypropylene with maleic acid, fumaric acid, or the like, or a polystyrene resin. These resins may be used alone or in combination of two or more.

A film, a laminate obtained by laminating multiple films, or the like including these resins may be formed by, for example, lamination using a dry lamination method, a wet lamination method, a non-solvent lamination method, a thermal lamination method, or the like, resin coating by extrusion lamination processing, coating with a heat sealant, or bonding through a hot melt adhesive or the like. Further, the film, the laminate, or the like including these resins does not necessarily need to be formed on the entire surface, and may be formed only on a part to be sealed.

Examples of the film include a polyolefin film made from polyethylene, polypropylene, a mixed resin of polyethylene and polypropylene, an ethylene-vinyl acetate copolymer resin, an ethylene-(meth)acrylic acid copolymer resin, an ethylene-methyl (meth)acrylate copolymer 12 resin, an ethylene-ethyl (meth)acrylate copolymer resin, an ethylene-vinyl alcohol copolymer resin, or the like.

Examples of a resin that can be used for the resin coating by extrusion lamination processing or the hot melt adhesive include a thermoplastic resin such as a polyethylene resin such as LDPE, LLDPE, or HDPE, a polypropylene resin, an ethylene-vinyl acetate copolymer, an ionomer resin, an ethylene-acrylic acid copolymer, an ethylene-ethyl acrylate copolymer, an ethylene-methyl acrylate copolymer, an ethylene-methacrylic acid copolymer, an ethylene-methyl methacrylate copolymer, an ethylene-propylene copolymer, a methylpentene polymer, an acid-modified polyolefin resin made by modifying polyethylene or polypropylene with maleic acid, fumaric acid, or the like, or a polystyrene resin. These resins may be used alone or in combination of two or more.

The thickness of the sealant is not particularly limited. However, from the viewpoint of sealing properties, costs, and productivity, it is preferable that the thickness is 2 μm to 200 μm for the film, 1 μm to 100 μm for the resin coating by extrusion lamination processing, 0.1 μm to 10 μm for the coating with the heat sealant, and 1 μm to 50 μm for the coating by the hot melt adhesive.

### [Adhesive Layer]

An adhesive layer can be provided, for example, between the base material and another base material or between the base material and the sealant. The adhesive layer is a layer formed for bonding two layers together using an adhesive or a tackifier (including wax and hot melt) that has adhesiveness or tackiness.

Examples of a resin for forming the adhesive layer include a resin with sealing properties used for forming the sealant described above, a urethane resin, a butadiene resin, a polyethyleneimine resin, an isocyanate resin, and a chelate. Further, a commercially available adhesive can be used as the resin for forming the adhesive layer. Further, the resin may be a one-component adhesive in which a base agent and a curing agent are mixed or a two-component adhesive in which a baes agent and a curing agent are separated. If the resin for forming the adhesive layer is the two-component adhesive, the base agent and the curing agent are adjusted at an appropriate mixing ratio and then mixed and used.

### [Printing Ink Layer]

As the printing ink layer, a conventional printing ink can be used and can be selected as appropriate depending on the base material. From the viewpoint of printability and versatility, the printing ink is preferably a gravure ink made from a urethane resin, a vinyl chloride-vinyl acetate copolymer resin, nitrified cotton, a polyamide resin, an acrylic resin, a chlorinated polypropylene resin, a polyester resin, or the like. The gravure ink may be made from one 13 type of these resins or a combination of two or more types. Further, when two or more color gravure inks are used, the gravure inks do not need to be made from the same resin, and the gravure inks made from different resins can be used as appropriate.

### [Anchor Coat Layer]

The anchor coat layer may be transparent, or may be formed using an anchor coat agent including a coloring material, making it possible to obtain many color variations and color designs. The anchor coat layer may be provided between the base material and the microwave heatable layer.

### [Overcoat Layer]

The overcoat layer can be formed using an overcoat agent, overcoat varnish, overprint varnish, or the like.

### [Other Layers]

Examples of other layers include an OPP film, an ONY film, a PET film, an EVOH film, a PVA film, a cellophane film, a barrier nylon film, a stretched polyethylene film, a (modified) polyacrylic acid coated film, a PVA coated film, a transparent vapor-deposited film in which an inorganic oxide such as aluminum oxide or silicon oxide is vapor-deposited onto a base material such as a biaxially stretched polyethylene terephthalate film, a transparent barrier film (K-coating) in which a base film such as OPP, ONY, PET, or cellophane is coated with polyvinylidene chloride (PVDC), and a barrier film in which an ethylene-vinyl alcohol copolymer resin is laminated so as to be sandwiched between OPP films or NY films. These films are preferably provided on the other side of the microwave heatable layer.

### <Method for Producing Microwave Heatable Film>

A method for producing a microwave heatable film according to one embodiment includes a step of forming at least one first microwave heatable region having a first area on at least one side of a base material (i.e., formation step of a first microwave heatable layer) and a step of forming one or more second microwave heatable regions each having a second area near the at least one first microwave heatable region (i.e., formation step of second microwave heatable layers).

The formation step of the first microwave heatable layer and the formation step of the second microwave heatable layers are preferably a printing step for forming a microwave heatable composition.

The printing step is preferably performed by at least one method selected from a silk screen printing method, a gravure printing method, an offset printing method, a flexographic printing method, a roller coating method, a brush coating method, a spray method, a knife jet coating method, an inkjet printing method, and the like. Of these, a gravure printing method, a 14 flexographic printing method, an inkjet printing method, or a silk screen printing method is preferably used due to their high quality and productivity. A gravure printing method is more preferably used for coating, and in particular, a gravure printing method using a multicolor gravure printing machine is still more preferably used. According to these methods, the microwave heatable layer can be provided at multiple sites and can be subjected to overprinting, making it easy to control openability of the steam-releasing opening and heat generation.

Further, after producing the base material on which one or more types of the microwave heatable compositions are laminated using a lamination method (overprinting of the microwave heatable compositions), the microwave heatable layer may be formed on one main surface of the base material by various printing methods. After forming the microwave heatable layer on one main surface of the base material using various printing methods, another base material may be formed on the other main surface of the base material by the lamination method described above. Further, the microwave heatable layer may be formed on both sides of the base material.

When the overcoat layer is provided on the microwave heatable layer, the overcoat layer can be formed using an overcoat agent, overcoat varnish, overprint varnish, or the like.

In the method for producing a microwave heatable film according to one embodiment, the printing step for forming the microwave heatable layer, the printing ink layer, and the anchor coat layer may be performed by the gravure printing method using one or more units of multicolor gravure printing machines. This allows the microwave heatable layer, the printing ink layer, the anchor coat layer, and the like to be continuously formed inline on the base material, making it possible to easily produce the microwave heatable film in single workflow (one path) at low cost. Further, this makes it easy to control the openability of the steam-releasing opening and the heat generation. If it is difficult to form these layers continuously inline due to a limitation of gravure printing machine specifications, printing environment, equipment, or the like, these layers may be formed offline (outline).

Further, when the microwave heatable layer is formed in the printing step using the gravure printing method, if 100% dot area ratio may cause too much heat generation or a requirement degree of the openability of the steam-releasing opening is changed, the openability and the heat generation can be easily controlled by reducing the area ratio, adjusting the cell depth, or adjusting the dilution rate.

The microwave heatable layer only needs to be formed in a part desired to be opened. The microwave heatable layer may be formed over the entire surface. Further, coating patterns different in designs, motifs, or the like may be formed depending on the shape of the steam-releasing opening and the requirement degree of the openability.

Further, the printing step is preferably performed by the gravure printing method that forms one or more colors of gravure inks. In this method, the printing ink layer can be formed as desired on the opposite side of the microwave heatable layer, between the base material and the microwave heatable layer, between the microwave heatable layer and the anchor coat layer, or the like.

Further, the printing step is preferably performed by the gravure printing method using a multicolor gravure printing machine. Since the microwave heatable layer is transparent with almost no coloration, when the printing ink layer is formed, the microwave heatable layer can be provided inline simultaneously with the printing ink layer without interfering with other pieces of information such as patterns, making it possible to obtain many color variations and color designs. For example, a package design or the like can be provided to improve a purchasing appeal effect, display information on where to open the package, how to open the package, warnings, or the like, notify a company name, a logo, a product name, a character, a content, an ingredient fact, an application method, or a campaign, and provide information on how to eat or use, date, a place of origin, a winning lottery ticket, or the like.

Further, a formation step of forming an intermediate layer, the anchor coat layer, the overcoat layer, or the like may be included. These layers are not particularly limited as long as they can be formed using a known formation step such as bonding or coating.

Each composition such as a microwave heatable composition, a printing ink, or an anchor coat agent can be produced by a known method by uniformly dissolving or dispersing a conductive organic compound, a resin, a pigment, a sealing resin, various additives, or the like in a solvent. Dissolution or dispersion can be performed by using various stirrers or dispersers such as a dissolver, a roll mill, a ball mill, a bead mill, a sand mill, an attritor, a paint shaker, an agitator, a Henschel mixer, a colloid mill, a pearl mill, an ultrasonic homogenizer, a wet jet mill, a kneader, and a homo-mixer. These devices may be used alone or in combination of two or more. If an air bubble or a coarse particle is included in each composition, an air bubble or a coarse particle is preferably removed by using a known filter, centrifuge, or the like since an air bubble or a coarse particle reduces printability and print quality.

The viscosity of each of the above compositions is not particularly limited as long as printing is not affected. Considering production suitability, handling, and the like of each composition, the viscosity is preferably 10 mPa·s to 1000 mPa·s at 25° C. Further, the viscosity of an ink for gravure printing is more preferably 10 mPa·s to 500 mPa·s.

Note that the viscosity can be measured using a commercially available viscometer such as a Brookfield viscometer.

The microwave heatable film according to one embodiment includes the microwave heatable layer, and the microwave heatable layer includes the microwave heatable composition according to one embodiment described above. In the microwave heatable film according to one embodiment, heat is generated in the microwave heatable layer upon microwave irradiation. Thus, when the microwave heatable layer is laminated on a heat-sealing portion, an opening can be formed from the heat-sealing portion through shrinkage of the film. Further, when the microwave heatable layer is provided in a center portion of the microwave heatable film, an opening can be easily formed from the center portion through breakage of the microwave heatable film. The microwave heatable film according to one embodiment has excellent base material binding properties and water resistance. Further, when the heat is generated in the microwave heatable film upon microwave irradiation during heating, an opening is easily formed in the microwave heatable film, thus the microwave heatable film can exhibit high steam permeability.

The microwave heatable film according to one embodiment having the above-mentioned characteristics can be suitably used as a microwave heatable film for package. In particular, the microwave heatable film can be effectively used as a microwave heatable film for steam-releasing package.

### <Microwave Heatable Package>

A microwave heatable package according to one embodiment includes the microwave heatable film according to one embodiment described above, and includes the microwave heatable layer formed on at least a part of the microwave heatable film.

The microwave heatable package may be in any form where a microwave heatable sheet is commonly used. The microwave heatable package may be in any form where a microwave heatable sheet is commonly used. The microwave heatable package may be in a form of two-sided sealing, three-sided sealing, four-sided sealing, pillow sealing, a standing pouch, envelope pasting, gazette packaging, melt-cut sealing, a tube, caramel wrapping, over-folded wrapping, fin seal wrapping, bun wrapping, twist wrapping, rocket wrapping, Tetra Pak (registered trademark), a Gable top carton, a brick carton, deep drawing packaging, a cup, a tray, a bottle, a brick carton, a container, a box, a case, a food container, a cover, a lid, a cap, a lid material, a label, a sheet, or the like.

A method for producing the microwave heatable package preferably includes a formation step of forming a package using the microwave heatable film.

In the formation step, the microwave heatable film may be formed into a package. One piece of microwave heatable film may be folded back and sealed at both ends to form a bag. Further, two pieces of microwave heatable films may be stacked to face each other and sealed at both ends to form a bag.

Further, in the formation step, the microwave heatable film may be used to cover a container, thereby forming a package.

The formation step may use a general method for forming a package, such as two-sided sealing, three-sided sealing, four-sided sealing, pillow sealing, a standing pouch, envelope pasting, gazette packaging, melt-cut sealing, a tube, caramel wrapping, over-folded wrapping, fin seal wrapping, bun wrapping, twist wrapping, rocket wrapping, Tetra Pak (registered trademark), a Gable top carton, a brick carton, deep drawing packaging, a cup, a tray, a bottle, a brick carton, a container, a box, a case, a food container, a cover, a lid, a cap, a lid material, a label, a sheet, or the like.

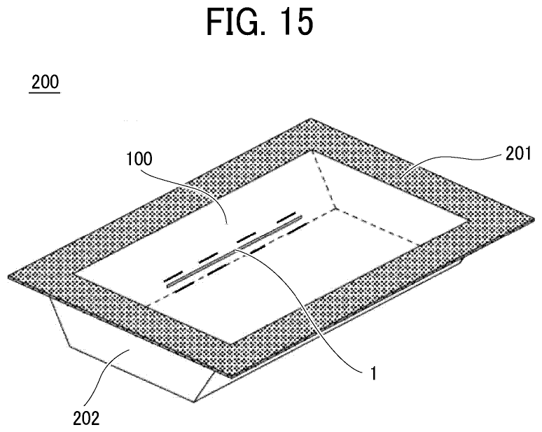

FIG. 15 is a diagram illustrating a configuration of the microwave heatable package according to one embodiment.

FIG. 15 is a diagram illustrating a microwave heatable package 200 using a microwave heatable film 100 according to one embodiment.

The microwave heatable package 200 is a packaging container in which the microwave heatable film 100 and a container 202 are heat-sealed in a heat-sealing portion 201. FIG. 15 is a perspective diagram of the microwave heatable package 200 in which the microwave heatable film 100 is disposed such that the microwave heatable layer 1 is positioned so as not to be vertically aligned with the heat-sealing portion 201 in a plan view.

In FIG. 15, the container 202 has a rectangular parallelepiped shape. However, the shape can be changed to any shape such as a cylindrical shape, a cubic shape, or a triangular prism shape depending on the content and design.

The microwave heatable package according to one embodiment includes the microwave heatable layer, and the microwave heatable layer includes the microwave heatable composition according to one embodiment described above. In the microwave heatable package according to one embodiment, heat is generated in the microwave heatable layer upon microwave irradiation during heating. When the microwave heatable layer is laminated on a heat-sealing portion, an opening is easily formed from the heat-sealing portion through shrinkage of the film. Further, when the microwave heatable layer is provided in a center portion of the microwave heatable film, an opening is easily formed from the center portion through breakage of the microwave heatable film. The microwave heatable film according to 18 one embodiment has excellent base material binding properties and water resistance. Further, when heat is generated in the microwave heatable film upon microwave irradiation during heating, an opening is easily formed in the microwave heatable package, thus the microwave heatable package can exhibit high steam permeability.

The microwave heatable package according to one embodiment having the above-mentioned characteristics can be suitably used as a package that is heated by using microwaves, for example, as a package for microwave oven heating.

The microwave heatable package according to one embodiment can have excellent base material binding properties and water resistance, as well as high steam permeability. Thus, for example, the microwave heatable package can be suitably used as a package or the like in which a through-hole is formed by microwave irradiation. Further, the microwave heatable package according to one embodiment can be suitably used, for example, as a cooking sheet or the like for browning a food material by microwave irradiation.

As described above, the embodiments have been described, but the embodiments are presented as examples, and the present invention is not limited to the embodiments described above. The embodiments described above can be implemented in various other forms, and various combinations, omissions, substitutions, changes, and the like can be made without departing from the gist of the invention. These embodiments and their modifications are included within the scope and gist of the invention, as well as within the invention described in the claims and equivalents thereof.

### EXAMPLES

Hereinafter, the embodiments are described in more detail with reference to Examples and Comparative examples. However, the embodiments are not limited to these Examples and Comparative examples.

### <Production of Microwave Heatable Composition>

### Production Example 1

A microwave heatable composition 1 was produced by mixing 40 parts by mass of a carbon black dispersion (9510MW, manufactured by Tokushiki Co., Ltd.), which was a conductive material, with 1.5 parts by mass of acrylic resin emulsion (MYK-2252, manufactured by Takamatsu Oil & Fat Co., Ltd.) and 2.0 parts by mass of ethanol.

### Production Example 2

A microwave heatable composition 2 was produced using the same production method as in Production example 1, except that 1.5 parts by mass of the acrylic resin emulsion in Production example 1 was changed to 7.5 parts by mass, and 2.0 parts by mass of ethanol was changed to 12 parts by mass.

### Production Example 3

A microwave heatable composition 3 was produced using the same production method as in Production example 1, except that 1.5 parts by mass of the acrylic resin emulsion in Production example 1 was changed to 15 parts by mass, and 2.0 parts by mass of ethanol was changed to 12 parts by mass.

### Production Example 4

A microwave heatable composition 4 was produced using the same production method as in Production example 1, except that 1.5 parts by mass of the acrylic resin emulsion in Production example 1 was changed to 26 parts by mass, and 2.0 parts by mass of ethanol was changed to 12 parts by mass.

### <Production of Microwave Heatable Film>

### Example 1

The microwave heatable composition 1 of Production example 1 was applied onto a sealant using a gravure printing machine in the coating shape illustrated in FIG. 6 to form a first microwave heatable region and second microwave heatable regions. The microwave heatable composition 1 was dried at 90° C. for 5 minutes, and then stored under the condition of 25° C. for 24 hours to produce a microwave heatable film 1. Note that the area of the first microwave heatable region (first area) was 60.0 mm², and the area of the second microwave heatable region (second area) was 6.0 mm². Further, the distance between the first microwave heatable region and the second microwave heatable region (distance 4 in FIG. 6) was set to 2.0 mm.

For sealing, 300 g of water-impregnated KIMTOWEL (manufactured by Nippon Paper Crecia Co., Ltd.) was placed in a PP container, and the container and the microwave heatable film 1 were heat-sealed under the condition of 180° C. for 1 second.

### Example 2

A microwave heatable film 2 was produced using the same production method as in Example 1, except that the distance (distance 4 in FIG. 6) between the first microwave heatable region and the second microwave heatable region formed into the coating shape illustrated in FIG. 6 in Example 1 was changed to 5.0 mm. Note that the area of the first microwave heatable region (first area) was 60.0 mm², and the area of the second microwave heatable region (second area) was 6.0 mm².

### Example 3

A microwave heatable film 3 was produced using same production method as in Example 1 except that microwave heatable composition 1 in Example 1 was changed to the microwave heatable composition 2. Note that the area of the first microwave heatable region (first area) was 60.0 mm², and the area of the second microwave heatable region (second area) was 6.0 mm².

### Example 4

A microwave heatable film 4 was produced using same production method as in Example 1 except that the microwave heatable composition 1 in Example 1 was changed to the microwave heatable composition 3. Note that the area of the first microwave heatable region (first area) was 60.0 mm², and the area of the second microwave heatable region (second area) was 6.0 mm².

### Example 5

A microwave heatable film 5 was produced using the same production method as in Example 1 except that the coating shape illustrated in FIG. 6 in Example 1 was changed to the coating shape illustrated in FIG. 7, and the distance (distance 4 in FIG. 7) between the first microwave heatable region and the second microwave heatable region was changed to 1.0 mm. Note that the area of the first microwave heatable region (first area) was 60.0 mm², and the area of the second microwave heatable region (second area) was 4.8 mm².

### Example 6

A microwave heatable film 6 was produced using the same production method as in Example 1 except that the coating shape illustrated in FIG. 6 in Example 1 was changed to the coating shape illustrated in FIG. 8. Note that the area of the first microwave heatable region (first area) was 60.0 mm², and the area of the second microwave heatable region (second area) was 4.8 mm².

### Example 7

A microwave heatable film 7 was produced using the same production method as in Example 1 except that the distance (distance 4 in FIG. 6) between the first microwave heatable region and the second microwave heatable region in Example 1 was changed to 110 mm. Note that the area of the first microwave heatable region (first area) was 60.0 mm², and the area of the second microwave heatable region (second area) was 6.0 mm².

### Comparative Example 1

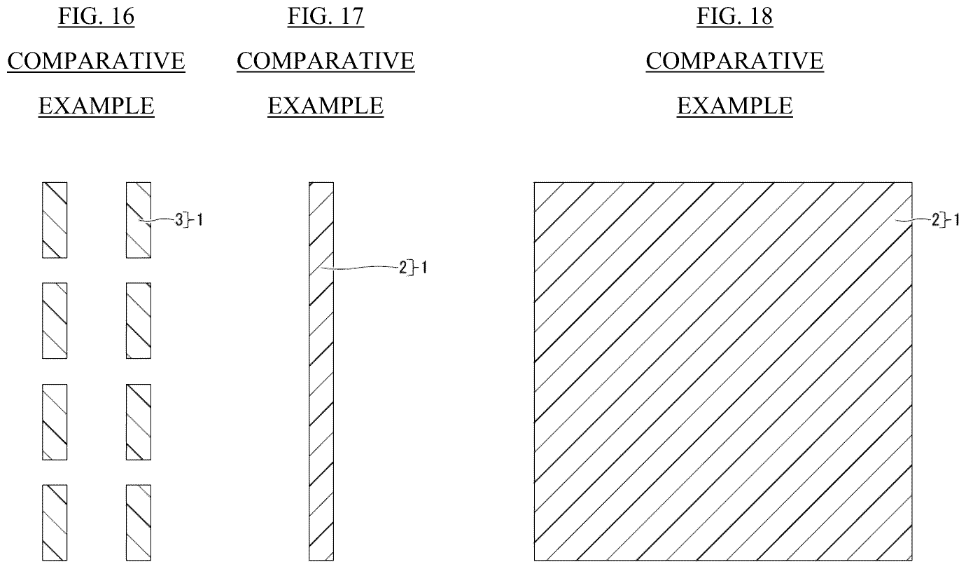

A microwave heatable film 8 was produced using the same production method as in Example 1 except that the coating shape illustrated in FIG. 6 in Example 1 was changed to the coating shape illustrated in FIG. 16 (that is, the first microwave heatable region was not provided). Note that the area of the second microwave heatable region (second area) was 15.0 mm².

### Comparative Example 2

A microwave heatable film 9 was produced using the same production method as in Example 1 except that the coating shape illustrated in FIG. 6 in Example 1 was changed to the coating shape illustrated in FIG. 17 (that is, the second microwave heatable region was not provided). Note that the area of the first microwave heatable region (first area) was 110.0 mm².

### Comparative Example 3

A microwave heatable film 10 was produced using the same production method as in Example 1 except that the microwave heatable composition 1 in Example 1 was changed to a silver ink (XA-4000, manufactured by Fujikura Kasei Co., Ltd.). Note that the area of the first microwave heatable region (first area) was 60.0 mm², and the area of the second microwave heatable region (second area) was 6.0 mm².

### Comparative Example 4

A microwave heatable film 11 was produced using the same production method as in Example 1 except that the microwave heatable composition 1 in Example 1 was changed to the microwave heatable composition 4. Note that the area of the first microwave heatable region (first area) was 60.0 mm², and the area of the second microwave heatable region (second area) was 6.0 mm².

### Comparative Example 5

A microwave heatable film 12 was produced using the same production method as in Example 1 except that the coating shape illustrated in FIG. 1 in Example 1 was changed to the coating shape illustrated in FIG. 18 (that is, solid coating was performed without providing the second microwave heatable region). Note that the area of the first microwave heatable region (first area) was 640 mm².

TABLE 1

| | | | | | | | | Shortest | |
|---|---|---|---|---|---|---|---|---|---|
| | | | | | | | | distance | Total area |
| | | | | | | | | between | of all first |
| | | | | | | | | first | microwave |
| | | | | | | | | microwave | heatable |
| | | | | | | | | heatable | regions |
| | | | | | | | | region and | and all |
| | | | | First microwave | | Second microwave | | second | second |
| | | | | heatable region | | heatable region | | microwave | microwave |
| | Microwave | | | First | Surface | Second | Surface | heatable | heatable |
| | heatable | | Coating | area | resistivity | area | resistivity | region | regions |
| | film No. | Ink No. | shape | (mm²) | (Ω/sq) | (mm²) | (Ω/sq) | (mm) | (mm²) |
| Example 1 | 1 | Microwave | FIG. 6 | 60. | 450 | 6.0 | 450 | 2.0 | 108 |
| | | heatable | | | | | | | |
| | | composition 1 | | | | | | | |
| Example 2 | 2 | Microwave | FIG. 6 | 60.0 | 225 | 6.0 | 225 | 5.0 | 108 |
| | | heatable | | | | | | | |
| | | composition 1 | | | | | | | |
| Example 3 | 3 | Microwave | FIG. 6 | 60.0 | 2100 | 6.0 | 2100 | 2.0 | 108 |
| | | heatable | | | | | | | |
| | | composition 2 | | | | | | | |
| Example 4 | 4 | Microwave | FIG. 6 | 60.0 | 5000 | 6.0 | 5000 | 2.0 | 108 |
| | | heatable | | | | | | | |
| | | composition 3 | | | | | | | |
| Example 5 | 5 | Microwave | FIG. 7 | 60.0 | 450 | 4.8 | 450 | 1.0 | 108 |
| | | heatable | | | | | | | |
| | | composition 1 | | | | | | | |
| Example 6 | 6 | Microwave | FIG. 8 | 60.0 | 450 | 4.8 | 450 | 2.0 | 108 |
| | | heatable | | | | | | | |
| | | composition 1 | | | | | | | |
| Example 7 | 7 | Microwave | FIG. 6 | 60.0 | 450 | 6.0 | 450 | 110.0 | 108 |
| | | heatable | | | | | | | |
| | | composition 1 | | | | | | | |
| Comparative | 8 | Microwave | FIG. 16 | — | — | 15.0 | 450 | — | 120 |
| example 1 | | heatable | | | | | | | |
| | | composition 1 | | | | | | | |
| Comparative | 9 | Microwave | FIG. 17 | 110.0 | 450 | — | — | — | 110 |
| example 2 | | heatable | | | | | | | |
| | | composition 1 | | | | | | | |
| Comparative | 10 | Microwave | FIG. 6 | 60.0 | 0.9 | 6.0 | 0.9 | 2.0 | 108 |
| example 3 | | heatable | | | | | | | |
| | | composition 1 | | | | | | | |
| Comparative | 11 | Silver ink | FIG. 6 | 60.0 | 13000 | 6.0 | 13000 | 2.0 | 108 |
| example 4 | | | | | | | | | |
| Comparative | 12 | Microwave | FIG. 18 | 640.0 | 450 | — | — | — | 640 |
| example 5 | | heatable | | | | | | | |
| | | composition 4 | | | | | | | |

### <Evaluation>

For evaluating each of the microwave heatable films of Examples and Comparative examples, steam permeability and controllability of the positions of the steam holes were evaluated.

### [Steam Permeability]

The heat-sealed container and film were heated in a microwave oven (RE-7500 manufactured by Sharp Corp.) at 500 W for 120 seconds, and evaluated based on the following evaluation criteria. The results are presented in Table 2.

### (Evaluation Criteria)

Good: Steam holes of 5 mm² or more were formed.

Fair: Steam holes of less than 5 mm² were formed.

Poor: No steaming.

### [Controllability of Steam Hole Position]

The heat-sealed container and film were heated in the microwave oven (RE-7500 manufactured by Sharp Corp.) at 500 W for 120 seconds, and evaluated based on the following evaluation criteria. The results are presented in Table 2. Note that “-” in Table 2 indicates no steaming.

### (Evaluation Criteria)

Good: Steaming occurred only from the inside of the target region 5 in the first microwave heatable region.

Fair: Steaming occurred from the inside of and near the target region 5 in the first microwave heatable area.

Poor: Steaming occurred sporadically.

Table 2 presents the evaluation results of the steam permeability and the controllability of the positions of the steam holes of the microwave heatable films.

TABLE 2

Evaluation results

| | Microwave | | Controllability |
|---|---|---|---|
| | heatable film | Steam | of steam hole |
| | No. | permeability | position |
| Example 1 | 1 | Good | Good |
| Example 2 | 2 | Good | Good |
| Example 3 | 3 | Good | Good |
| Example 4 | 4 | Fair | Good |
| Example 5 | 5 | Good | Good |
| Example 6 | 6 | Good | Good |
| Example 7 | 7 | Good | Fair |
| Comparative | 8 | Poor | — |
| example 1 | | | |
| Comparative | 9 | Poor | — |
| example 2 | | | |
| Comparative | 10 | Poor | — |
| example 3 | | | |
| Comparative | 11 | Poor | — |
| example 4 | | | |
| Comparative | 12 | Good | Poor |
| example 5 | | | |

Based on Table 2, it was confirmed that, as a mean for generating heat by microwave irradiation, Examples 1 to 7 could exhibit the higher steam permeability capable of steaming even with a small coating area in the microwave heatable region, and the higher controllability of the positions of the steam holes, compared to Comparative examples 1 to 5.

Note that aspects of the embodiments of the present invention are, for example, as follows.

### <Aspect 1>

A microwave heatable film including:
at least one first microwave heatable region having a first area; and
one or more second microwave heatable region each having a second area, in which: the first area is larger than the second area in a plan view; and
the first microwave heatable region and the second microwave heatable regions each have a surface resistivity of 5 Ω/sq to 10,000 Ω/sq.

### <Aspect 2>

The microwave heatable film according to the above Aspect 1, in which the second microwave heatable regions have a circular, elliptical, polygonal, or wavy shape in the plan view.

### <Aspect 3>

The microwave heatable film according to the above Aspect 1 or 2, in which a shortest distance between the at least one first microwave heatable region and the one or more second microwave heatable regions is 100 mm or less.

### <Aspect 4>25

The microwave heatable film according to any of the above Aspects 1 to 3, in which the one or more second microwave heatable regions include a plurality of second microwave heatable regions, and the plurality of second microwave heatable regions are disposed along a longitudinal direction of the at least one first microwave heatable region.

### <Aspect 5>

The microwave heatable film according to any of the above Aspects 1 to 3, in which the one or more second microwave heatable regions include a plurality of second microwave heatable regions, and the plurality of second microwave heatable regions are disposed on left and right sides of the at least one first microwave heatable region in the plan view.

### <Aspect 6>

A microwave heatable package including the microwave heatable film according to any one of the above Aspects 1 to 5.

### <Aspect 7>

A method for producing a microwave heatable film, the method including:
forming at least one first microwave heatable region having a first area on at least one side of a base material having a rectangular shape; and
forming one or more second microwave heatable regions each having a second area near the at least one first microwave heatable region, in which:
the first area is larger than the second area in a plan view; and
the first microwave heatable region and the second microwave heatable regions each have a surface resistivity of 5 Ω/sq to 10,000 Ω/sq.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2023-095770, filed on Jun. 9, 2023, in the Japan Patent Office, the entire disclosure of which is hereby incorporated by reference herein.

### REFERENCE SIGNS LIST

1 Microwave heatable layer
2 First microwave heatable region
3 Second microwave heatable region
4 Shortest distance between first microwave heatable region and second microwave heatable region
5 Target region
11 Base material
12 Base material with sealing properties
13 Sealant
100 to 104 Microwave heatable film
200 Microwave heatable package
201 Heat-sealing portion
202 Container

1. A microwave heatable film, comprising:
at least one first microwave heatable region having a first area; and
one or more second microwave heatable regions each having a second area,
wherein:
the first area is larger than the second area in a plan view; and
the at least one first microwave heatable region and the one or more second microwave heatable regions each have a surface resistivity of 5 Ω/sq to 10,000 Ω/sq.

2. The microwave heatable film according to claim 1, wherein the one or more second microwave heatable regions have a circular, elliptical, polygonal, or wavy shape in the plan view.

3. The microwave heatable film according to claim 1, wherein a shortest distance between the at least one first microwave heatable region and the one or more second microwave heatable regions is 100 mm or less.

4. The microwave heatable film according to claim 1, wherein the one or more second microwave heatable regions include a plurality of second microwave heatable regions, and the plurality of second microwave heatable regions are disposed along a longitudinal direction of the at least one first microwave heatable region.

5. The microwave heatable film according to claim 1, wherein the one or more second microwave heatable regions include a plurality of second microwave heatable regions, and the plurality of second microwave heatable regions are disposed on left and right sides of the at least one first microwave heatable region in the plan view.

6. A microwave heatable package, comprising:
the microwave heatable film according to claim 1.

7. A method for producing a microwave heatable film, the method comprising:
forming at least one first microwave heatable region having a first area on at least one side of a base material having a rectangular shape; and
forming one or more second microwave heatable regions each having a second area near the at least one first microwave heatable region,
wherein:
the first area is larger than the second area in a plan view; and
the at least one first microwave heatable region and the one or more second microwave heatable regions each have a surface resistivity of 5 Ω/sq to 10,000 Ω/sq.
